(19) United States
(12) Patent Application Publication
(10) Pub. No.: US 2005/0244251 A1
(43) Pub. Date: Nov. 3, 2005

(54) Conductive spacer apparatus and method

(76) Inventors: Kenneth G. Seidl, Port Washington, WI (US); Jeremy Bogard, Booneville, MS (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/846,057

(22) Filed: May 14, 2004

Related U.S. Application Data
(60) Provisional application No. 60/566,230, filed on Apr. 28, 2004.

(51) Int. Cl. F16B 43/02

(52) U.S. Cl. 411/546

(57) ABSTRACT

Apparatus and method for a conductive spacer constructed of nylon (polyamide), plastic, or polyester and embedded or impregnated with carbon fibers for use in a leg lift or actuation mechanism of a reclining chair or seating unit.

### BACKGROUND OF THE INVENTION

Washers can be used in various positions on the leg rest or actuation mechanism of a reclining chair or a seating unit having one or more reclining portions. Washers can reduce noise and provide lubrication between moving mechanical linkages.

The leg rest or actuation mechanism of a reclining chair or seating unit is often painted using an electrostatic paint spray system. An electrostatic paint spray system is a technology for the application of paint to specific workpieces. Negatively-charged atomized paint particles and a grounded workpiece create an electrostatic field that draws the paint particle to the workpiece, minimizing overspray. For this technology, an ionizing electrode, typically located at the paint gun atomizer tip, causes paint particles to pick up additional electrons and become negatively charged. As the coating is deposited on the workpiece, the charge dissipates through the ground and returns to the power supply, completing the circuit. The electrostatic field influences the path of the paint particles. Electrostatic paint equipment is available in three basic types: air atomized, airless, and rotating discs and bells. All primers, paints, and coatings applied by electrostatic spray systems must be formulated with polarizable solvents. Any material that can be atomized can accept an electrostatic charge, regardless of the coating conductivity. The workpiece must also be groundable. Metal and some wooden pieces can be painted electrostatically, but plastic, rubber, ceramic, and glass generally cannot be painted electrostatically.

When non-conductive washers are used in the leg rest or actuation mechanism, the conductive path of the charge being applied by the electrostatic paint spray system is interrupted, resulting in portions of the leg rest or actuation mechanism not being adequately coated with paint particles. One conventional solution to this problem is to use oil-impregnated metal washers, which provide a conductive path for the charge being applied by the electrostatic paint spray system. However, oil-impregnated metal washers can create additional friction between the mechanical linkages and can become worn after repeated use of the leg rest or actuation mechanism.

### SUMMARY OF THE INVENTION

In light of the problems described above, a need exists for a spacer that is at least partially conductive, provides noise reduction, provides lubrication, is durable, and is simple to manufacture for use in the leg rest or actuation mechanism of a reclining chair or seating unit. One embodiment of the invention provides a spacer constructed of non-conductive nylon (polyamide), plastic, or polyester embedded or impregnated with conductive carbon fibers.

Other features and advantages of the invention are set forth in the following in the following detailed description, drawings, and claims.

### BRIEF DESCRIPTION OF THE DRAWINGS

FIG. 1 is a perspective view of a reclining chair including a conductive spacer according to one embodiment of the invention.

FIG. 2 is a perspective view of a multi-person seating unit including a conductive spacer according to one embodiment of the invention.

FIG. 3 is a perspective view of an actuation mechanism for use in the reclining chair of FIG. 1 or the multi-person seating unit of FIG. 2.

FIG. 4 is a side view of a leg rest mechanism for use in the reclining chair of FIG. 1 or the multi-person seating unit of FIG. 2.

FIGS. 5A-5C include top and side views of conductive spacers according to several embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings and can include electrical connections and couplings, whether direct or indirect. Furthermore, and as described in subsequent paragraphs, the specific mechanical configurations illustrated in the drawings are intended to exemplify embodiments of the invention and that other alternative mechanical configurations are possible.

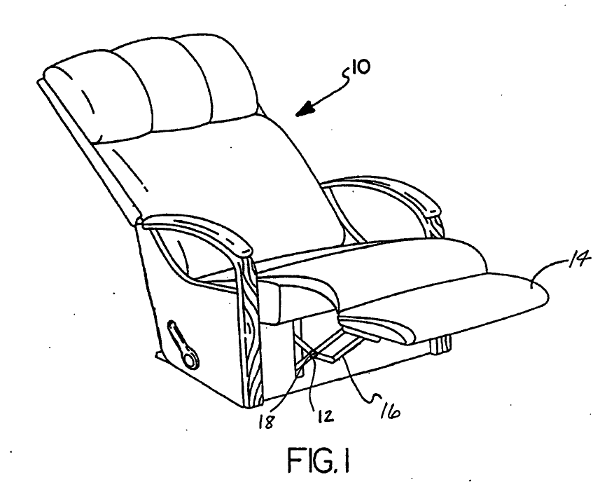

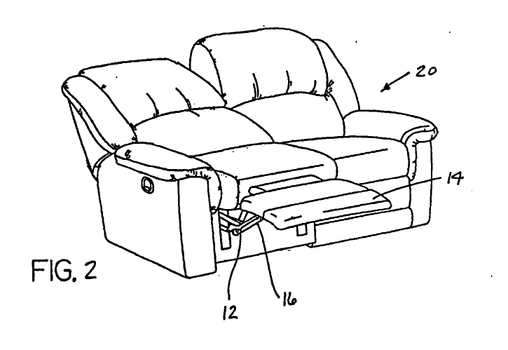

FIG. 1 illustrates a reclining chair 10 including a conductive spacer or washer 12 according to one embodiment of the invention. The reclining chair 10 includes a leg rest mechanism 14 that can include several mechanical linkages 16. The conductive spacer 12 can be positioned at one or more points in the leg rest mechanism 14 between mechanical linkages 16 that are coupled to one another with fasteners 18 (e.g., rivets, bolts, screws, pins, etc.). Although shown for use in the reclining chair 10, the conductive spacer 12 can be used in virtually any type of single or multi-person seating unit or article of furniture, whether in a leg rest or actuation mechanism or any other portion of the seating unit or article of furniture. FIG. 2 illustrates an example of the conductive spacer 12 being used in the leg rest mechanism of a multi-person seating unit 20.

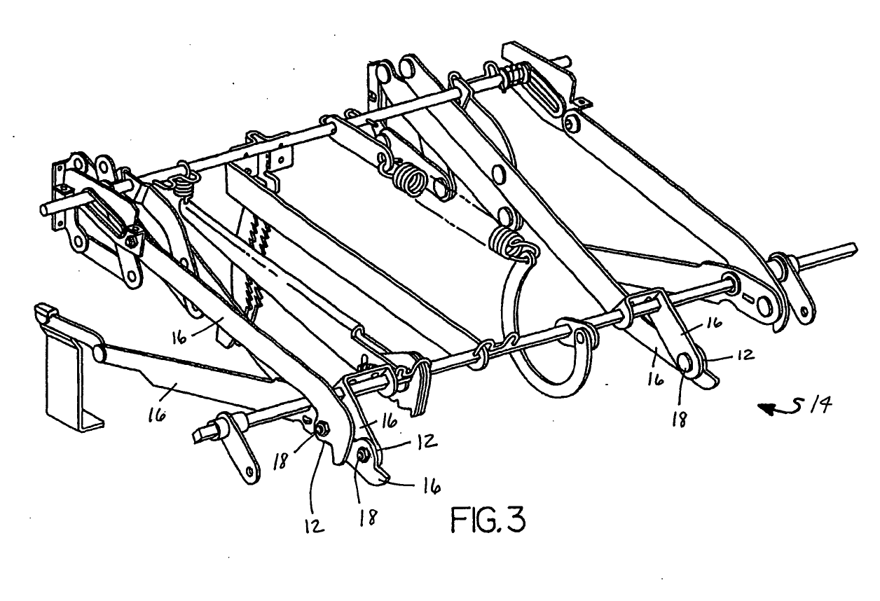

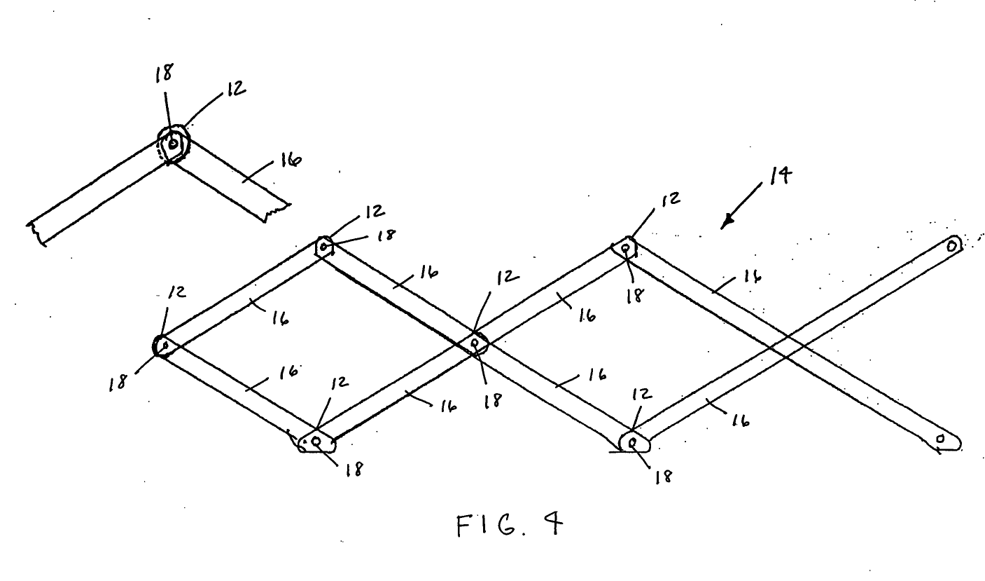

FIG. 3 illustrates an example of an actuation mechanism 14 for use in the reclining chair 10 or the multi-person seating unit 20. FIG. 4 illustrates an example of a leg rest mechanism 14 for use in the reclining chair or the multi-person seating unit 20. The leg rest or actuation mechanisms 14 include several mechanical linkages 16 coupled to one another in any suitable configuration by fasteners 18 with conductive spacers 12 being positioned between the mechanical linkages 16.

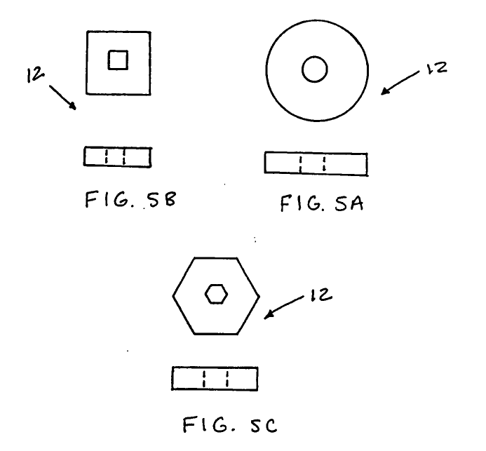

FIGS. 5A-5C illustrate conductive spacers 12 according to several embodiments of the invention. As shown in FIG. 5A, the conductive spacer 12 can have a round shape in some embodiments. The conductive spacer 12 can have other suitable shapes in other embodiments, such as a square shape (FIG. 5B) or a hexagonal shape (FIG. 5C). In some embodiments, the shape of the conductive spacer 12 can be designed according to the shape of the head of the fasteners 18. The conductive spacer 12 can have any suitable diameter, such as approximately 0.75 inches or a diameter that exceeds the diameter of the head of the fasteners 18 or the width of the mechanical linkages 16. Also, the conductive spacer 12 can have any suitable thickness, such as approximately 0.03 inches or approximately 0.06 inches.

In some embodiments, the conductive spacer 12 can be constructed of two or more materials in order to provide noise-reduction, lubrication, and durability properties, as well as conductive properties. In general, the conductive spacer 12 can be at least partially conductive. In one embodiment, the conductive spacer 12 can be constructed of any suitable nylon (polyamide), plastic, or polyester non-conductive material impregnated or embedded with conductive carbon fibers. In one embodiment, the conductive spacer 12 can be constructed of 70 percent nylon-6,6 and 30 percent carbon fibers. Other ratios of nylon to carbon fiber can be used in order to provide the appropriate mechanical properties and the appropriate conductive properties.

The carbon fibers impregnated or embedded in the conductive spacer 12 can provide a conductive path for a charge being applied to the leg lift or actuation mechanism 14 during an electrostatic painting process. The carbon fibers can protrude slightly from the conductive spacer 12 in order to conduct the charge from one side of the conductive spacer 12 to the other side of the conductive spacer 12. As a result, the charge can be conducted to the mechanical linkages 16 and the entire leg left or actuation mechanism 14 can be adequately coated with paint particles. In one embodiment, the conductive spacer 12 can introduce approximately 350 ohms of resistance from one side of the conductive spacer 12 to the other side of the conductive spacer 12. In other embodiments, the conductive spacer 12 can introduce up to approximately 500 ohms of resistance from one side of the conductive spacer 12 to the other side of the conductive spacer 12.

According to a method of the invention, the conductive spacers 12 can be manufactured using an injection molding process or any other suitable manufacturing process. Nylon, plastic, or polyester can be impregnated with carbon fibers and then injected into the desired molds. A leg rest or actuation mechanism 14 can be assembled with the conductive spacers 12 being placed between mechanical linkages 16. Once assembled, the leg rest or actuation mechanism 12 can be painted using an electrostatic paint spray system. The charge applied to the leg rest or actuation mechanism 12 by the electrostatic paint spray system can be conducted through the mechanical linkages 16, the conductive spacers 12, and/or the fasteners 18. As a result, paint particles can adequately coat the entire leg rest or actuation mechanism 14.

Various features and advantages of the invention are set forth in the following claims.

1. A conductive spacer for use in a leg rest or actuation mechanism of a reclining chair or seating unit, the conductive spacer comprising a member constructed of at least nylon and carbon fibers.

2. The conductive spacer of claim 1 wherein the nylon includes nylon-6,6.

3. The conductive spacer of claim 1 wherein the member is constructed of 70 percent nylon and 30 percent carbon fiber.

4. The conductive spacer of claim 1 wherein the member has one of a round shape, a square shape, and a hexagonal shape.

5. The conductive spacer of claim 1 wherein the member has a thickness of one of approximately 0.03 inches and approximately 0.06 inches.

6. The conductive spacer of claim 1 wherein the member has a diameter of approximately 0.75 inches.

7. The conductive spacer of claim 1 wherein the member introduces up to approximately 500 ohms of resistance.

8. A conductive spacer for use in a leg rest or actuation mechanism of a reclining chair or seating unit, the conductive spacer comprising a member constructed of at least plastic and carbon fibers.

9. A conductive spacer for use in a leg rest or actuation mechanism of a reclining chair or seating unit, the conductive spacer comprising a member constructed of at least polyester and carbon fibers.

10. A method of painting a leg rest or actuation mechanism of a reclining chair or seating unit, the method comprising:
assembling a leg rest or actuation mechanism with conductive spacers coupled between mechanical linkages, the conductive spacers being constructed of at least nylon and carbon fiber;
applying a charge to the leg rest or actuation mechanism with an electrostatic paint spray system, the charge being conducted through the conductive spacers and the mechanical linkages; and
adhering paint particles to at least the mechanical linkages of the leg rest mechanism.

11. A method of manufacturing a conductive spacer, the method comprising:
embedding a nylon-6,6 material with carbon fibers; and
injection molding the nylon-6,6 material embedded with carbon fibers to produce a conductive spacer.
